(19) United States
(12) Patent Application Publication
(10) Pub. No.: US 2019/0208890 A1
(43) Pub. Date: Jul. 11, 2019

(54) EYELASH WASHING DEVICE

(71) Applicant: Ruth Bailey Schow, Farmington, UT (US)

(72) Inventor: Ruth Bailey Schow, Farmington, UT (US)

(21) Appl. No.: 15/864,100

(22) Filed: Jan. 8, 2018

(51) Int. Cl. A45D 34/04; B08B 3/12

(52) U.S. Cl. CPC A45D 34/04; A41G 5/02; B08B 3/12

(57) ABSTRACT

A device for washing eyelashes or eyelash extensions, including: a basin with a vent; and a compressible reservoir, the reservoir providing fluid to the basin through the vent and receiving fluid from the basin through the vent.

### BACKGROUND

The coloring of eyelashes with mascara is used to modify appearance. Eyelash extensions are also used to modify the appearance of the eyelashes. However, cleaning eyelash extensions can be challenging without removing them and reapplying them. Removal and replacement takes time.

### BRIEF DESCRIPTION OF THE DRAWINGS

The accompanying drawings illustrate various examples of the principles described herein and are a part of the specification. The illustrated examples are merely illustrative and do not limit the scope of the claims. Like numerals denote like but not necessarily identical elements.

FIG. 1 shows an example of a device for cleaning eyelashes according to one example consistent with the present disclosure.

FIGS. 2A-C show the use of a device for cleaning eyelashes according to one example consistent with the present disclosure.

FIGS. 3A-D show examples of vent patterns consistent with the present disclosure.

FIG. 4 is a flowchart for a method of cleaning eyelashes or eyelash extensions.

FIG. 5 shows a cross-sectional view of an example of a device for cleaning eyelashes according to one example consistent with the present disclosure.

FIG. 6A-C show cross-sectional views of some examples of plates with vents consistent with the present specification.

Throughout the drawings, identical reference numbers designate similar, but not necessarily identical, elements.

### DETAILED DESCRIPTION

Artificial eyelash extensions are used to modify the appearance of the eyelashes and are widely available with many application methods. The permanent application of a full set of lashes will last without touchup appointment for up to four weeks if taken care of properly. These eyelash extensions are generally secured with a minuscule amount of liquid adhesive on an extension and secured to a single natural lash. Eyelashes and eyelids need to be cleaned daily to prevent buildup of dead skin cells and natural oils from being trapped in the lash line along the eyelid.

One challenge with mechanically rubbing the eyelashes is the tendency to get material from the eyelashes into the eye. This may result in irritation and/or infection. Further, the adhesives used to secure eyelash extensions to the eye may have poor resistance to sheer. This property of the adhesive makes removal of eyelash extension easier. However, low sheer strength may also make the eyelash extensions vulnerable to unintentional dislodgement when attempting to clean the eyelash extension while attached to the eyelid.

Another option for eyelash extensions is to remove them periodically and then reapply them. Reapplication of eyelash extensions may take time and may be reduced if the extensions can be kept clean at home. Removal and reapplication is costly and may create irritation to the eye.

The present specification among the other examples, describes a tool to facilitate cleaning of the eyelashes and and/or eyelash extensions attached to the natural lashes. The tool includes a basin to hold liquid and an agitator to agitate liquid in the basin.

The present specification also describes a basin with a vent and a compressible reservoir, the reservoir providing fluid to the basin through the vent and receiving fluid from the basin through the vent.

This specification also describes: a device for washing eyelashes and eyelash extensions, the device including: a basin with a vent; and a reservoir supporting the basin, wherein compressing the reservoir provides fluid to the basin and allowing the reservoir to relax allows the fluid to return to the reservoir.

In an example consistent with the present specification, a device for washing eyelashes and/or eyelash extensions includes: a basin proportionate to the eye and an agitator to agitate fluid in the basin.

One example, consistent with the present specification, describes a device for washing eyelashes, including a basin including: a rest for supporting the bridge of the nose and/or a portion of the ocular socket, and an overflow vent; and an agitator to agitate liquid in the basin.

Another example described herein is a device for washing eyelashes and eyelash extensions, including: a basin, including: an inlet to receive fluid; a vent to expel fluid and maintain a height of the fluid in the basin; and a rest to stabilize the basin against a portion of a face.

This specification also describes a method of cleaning eyelashes and eyelash extensions, including: providing fluid through a vent into a basin, where passage through the vent agitates the fluid in the basin; introducing eyelashes and/or eyelash extensions into the basin; and retrieving the fluid through the vent from the basin.

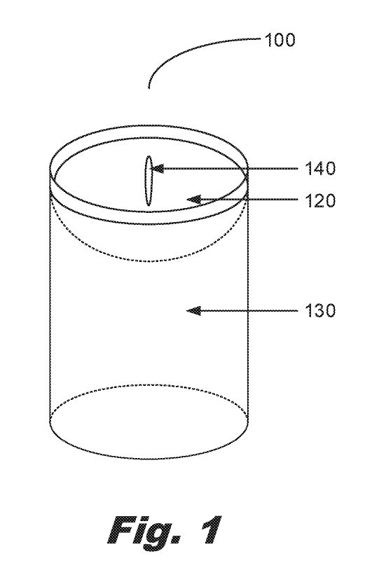

Turning now to the figures, FIG. 1 shows an example of a device (100) for cleaning eyelashes (110) according to one example consistent with the present disclosure. The device includes a basin (120) with a vent (140). The device (100) also includes a reservoir (130). The vent (140) connects the basin (120) and the reservoir (130).

The basin (120) may interface with the reservoir (130). In an example, the basin (120) is mounted on top of the reservoir (130). The basin (120) can hold a volume of liquid. The basin (120) may be removable from the reservoir (130). The basin (120) may be fixed to the reservoir (130) such that they cannot be easily separated.

The reservoir (130) includes a chamber allowing the reservoir (130) to hold liquid. The liquid is used for cleaning the eyelashes and/or eyelash extensions. The reservoir (130) may include a lip and/or keyed features to support and/or secure the basin relative to the reservoir. In an example, the basin may attach to the reservoir in two different rotational orientations 180 degrees apart from each other. The two orientations may provide different flow patterns through the vent (140). For example, a first configuration may be a low pressure flow pattern and the second configuration may be a higher pressure flow pattern. The different configurations may result from asymmetries of the vent (140) and asymmetry of features on the interior of the reservoir (130). For example, in one orientation, obstructions on the interior of the reservoir (130) may obstruct portions of the vent reducing the flow rate of fluid into the reservoir.

In an example, the reservoir (130) is flexible and compressing the reservoir expels liquid through the vent (140) into the basin (120). The compression may then be relaxed and the fluid in the basin (120) returns to the reservoir (130) via the vent (140). The volume change in the reservoir (130) transfers sufficient fluid into the basin to allow washing of the eyelashes without overflowing the basin. The reservoir (130) may have a convex outer surface that inverts to concave when compressed. This shape change provides most of the volume change and additional volume change uses higher force, limiting the volume change to the desired volume transfer to the basin. This allows predictable filling of the basin (120) by the user without having to carefully monitor the fluid level in the basin as they can rely on the force applied to the outside of the reservoir to avoid spraying liquid onto their face.

In an example, the reservoir (130) includes a surface that may be pushed into the reservoir (130) to reduce the volume. For example, the surface may be a bottom surface of the reservoir (130). The surface may be a plunger that passes through a side of the reservoir (130). The surface maybe actuated using the fingers. The surface may be actuated automatically in response to activating the device (100). In an example, the surface actuates at fixed intervals, for example, 5 actuations separated by 1 second apiece. The automated actuation of the surface may be coupled to an ultrasound source which provides agitation of fluid in the device (100).

The vent (130) may be a hole. The vent (130) may be a plurality of holes. The holes may be of uniform size. The holes may be of different sizes. The vent (130) may be a slot. The vent (130) may be a plurality of slots. The vent shape, size, and distribution on the surface of the basin (120) may be adjusted to modify performance of the device (100). For example, if the vent is large, the fluid will pass relatively uniformly from the reservoir to the basin (120), this may result in little and/or no agitation of the fluid in the basin, reducing the cleaning effectiveness. If the vent is small, the fluid may spray outside the basin (120), making a mess and/or irritating the user by contacting other portions of the face. The vent (140) may be sized to produce vigorous agitation without splashing of the liquid as the liquid moves from the reservoir (130) into the basin (120).

The vent (140) may be arranged symmetrically in the basin. The vent(s) (140) may be arranged asymmetrically in the basin. In an example, the vent (140) is arranged to produce a directed flow lateral to the principle axis of the eyelashes. In another example, the vents are arranged to provide turbulent agitation of the fluid. The vents may be arranged to compensate for excessive compression of the reservoir. For example, the vent (130) may include a slot and/or opening near the maximum desire liquid level in the basin to act as a pressure relief.

The eyelashes (110) may be natural and/or artificial lashes. The eyelashes (110) may have mascara, dead skin cells, natural oils, cleansers, make-up remover, and/or other materials on them.

The basin may be a polymer, a glass, a metal, a composite, wood, and/or another suitable material. In an example, the basin (120) is an injection molded part. In another example, the basin (120) is a cast part. The basin (120) may be a machined part. The basin may be polyethylene (PE, HOPE, LOPE), polypropylene (PP), polycarbonate (PC), polyurethane (PU), polystyrene (PS), polyimide (PI), and/or a similar polymer. The basin may be transparent and/or include a window to allow a user to seen the fluid in the reservoir. The basin (120) may be opaque. The basin may be formed from a plurality of materials. For example, the basin may include a softer material, such as a silicone rubber, on the face-contacting surfaces.

The reservoir (130) may be formed from any suitable material. In an example, the reservoir (130) is a polymer. The reservoir (130) may be an injection molded component

The reservoir (130) may include a level indicator to indicate a target amount of liquid for operation. In an example, the reservoir is transparent and the level indicator is a molded line. The level indicator may be printed on the reservoir (130). The level indicator may be a texture and/or physical feature on the interior and/or exterior of the reservoir (130).

The reservoir (130) may include a weep hole at the desired fill level. In an example, the weep hole is located such that the weep hole is sealed by a user's finger and/or hand when compressing the reservoir (130).

The reservoir (130) may include a stop. A stop is a physical feature, such as a pin, peg, ridge, attached to the interior of the reservoir that contacts another portion of the interior of the reservoir when the reservoir is compressed, limiting the amount of compression of the reservoir. For example, the stop may limit the volume change of the reservoir to no more than 10 ml.

The reservoir (130) may include a shutter. A shutter is a component on and/or a portion of the interior of the reservoir (130) which modifies flow through one or more vents (140) as the reservoir is compressed. In an example, a shutter seals and/or reduces flow through a vent. In another example, a shutter opens an obstructed vent. A shutter may also be used to change the direction of fluid flow through the vent and into the basin. A shutter may reduce the cross section of the vent (140) to modify the mixing once a given amount of liquid is present in the basin (120).

The basin (120) may include an agitator to move fluid in the basin. The basin (120) may include a mechanical and/or electrical oscillator to vibrate the liquid in the basin. In an example, an ultrasonic agitator may be attached to a portion of the basin and induce vibration in the liquid in the basin. The agitator may be electrically, mechanically, and/or hydraulically powered. In an example, the agitator is a spring powered mechanical device. In another example, the agitator is electrically powered and activates when fluid bridges two electrical elements in the basin.

The basin (120) and reservoir (130) may be formed from the same material. The basin (120) and reservoir (130) may be formed from different materials. In an example, the basin (120) is stiffer than the reservoir (130) in a favored axis of compression of the reservoir (130). This may be a result of material selection and/or geometry.

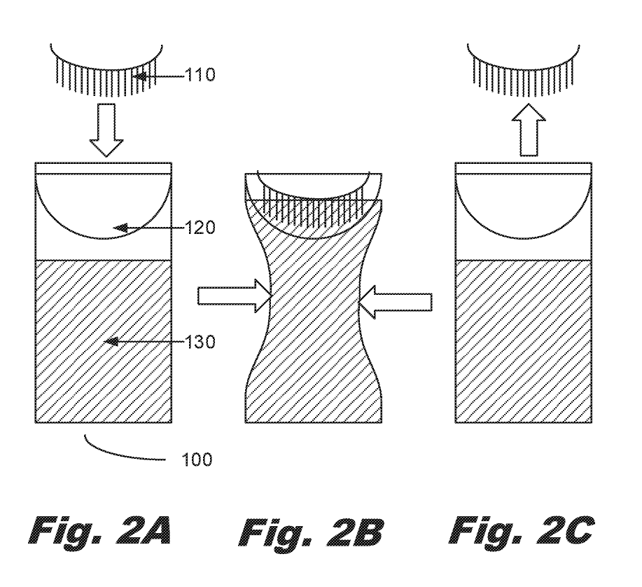

FIGS. 2A-C show operation of an example device (100) consistent with the present disclosure. The device (100) includes a basin (120) and a reservoir (130). The reservoir (130) contains a fluid. As seen in FIG. 2A, the eyelashes (110) are brought into the basin (120). In FIG. 2B, the reservoir (130) is compressed to reduce its volume, forcing fluid into the basin (120) through the vent(s) (140, not shown). This agitates the fluid to provide good rinsing. The compression on the reservoir (130) is relaxed and the fluid returns to the reservoir (130) from the basin (120). As seen in FIG. 2C, the eyelashes (110) may then be withdrawn. Clearly, variations of this process are also disclosed. For example, the reservoir (130) may be compressed and relaxed multiple times while the eyelashes (110) are in the basin (120). The eyelashes (110) may be introduced into the basin (120) after filling the basin (120) with fluid. The eyelashes (110) may be withdrawn from the basin (120) prior to relaxing the reservoir (130).

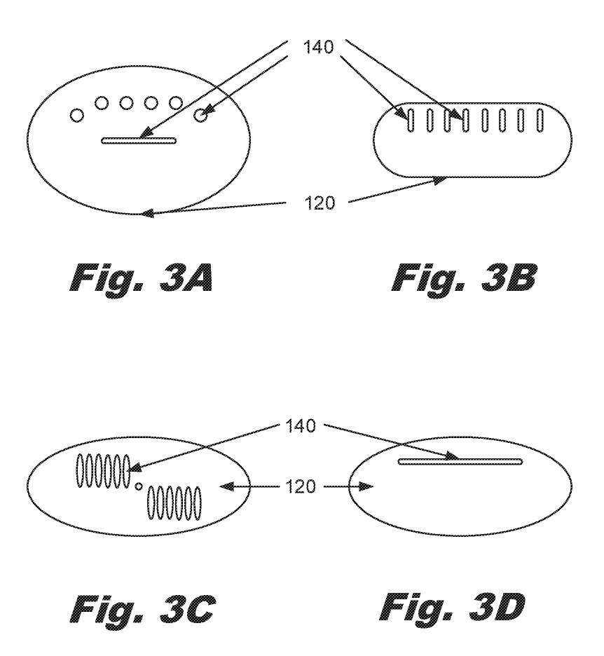

FIGS. 3A-D show examples of different vent (140) patterns that may be used. Different vent (140) patterns may produce different filling, flow, and/or draining profiles. The vent (140) pattern and size of the vent (140) and/or vents (140) may be adjusted to modify the amount of agitation in the basin (120). Increasing the size and/or number of the vent(s) (140) will decrease the pressure of the fluid filling the basin (120). Similarly, decreasing the size and/or number of vents will increase the pressure of the fluid filling the basin (120). Higher pressure may produce greater flow and greater agitation of the fluid in the basin (120).

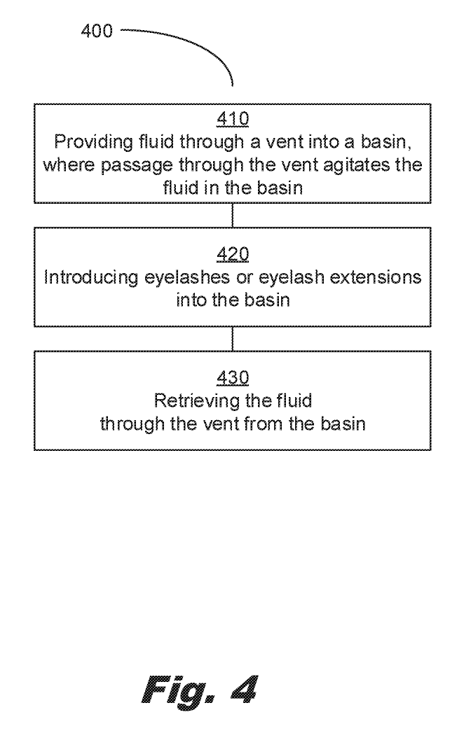

FIG. 4 shows a flowchart of a method of cleaning eyelashes and eyelash extensions (400), including: providing fluid through a vent (140) into a basin (120), where passage through the vent (140) agitates the fluid in the basin (120) (410); introducing eyelashes and/or eyelash extensions (110) into the basin (120) (420); and retrieving the fluid through the vent (140) from the basin (120) (430).

This method (400) may be used with eyelashes and/or with eyelash extensions. This method (400) is a method of cleaning the eyelashes and/or eyelash extensions while they are in place, i.e., on the eyelid.

This method (400) includes: providing fluid through a vent (140) into a basin (120), where passage through the vent (140) agitates the fluid in the basin (120) (410). Using the vent (140) to produce the agitation of the fluid simplifies the operation and increases cleaning. For example, static fluid is less effective at removing material compared with agitated fluid.

The method (400) also includes: introducing eyelashes and/or eyelash extensions (110) into the basin (120) (420). The eyelashes and/or eyelash extensions (110) contact the fluid in the basin (120). This allows material on the eyelashes and/or eyelash extensions to wash away into the fluid.

The method (400) also includes: retrieving the fluid through the vent (140) from the basin (120) (430). Using the same vent(s) (140) to provide and recover the fluid simplifies the design by using a single reservoir (130) to provide the fluid and capture the used fluid. The used fluid is diluted in the reservoir and the fluid may be changed out between eyes and/or after use.

Additional activities may be included in the method (400). For example, the fluid maybe provided and removed multiple times, e.g., until the eyelash is clean. The fluid may be added to the reservoir (130) as part of the method (400). The fluid may be added to the reservoir (130) until the fluid reaches a fill line. Ultrasonic agitation may be provided, either directly into the basin (120) and/or into the reservoir (130) and conducted to the eyelashes (110).

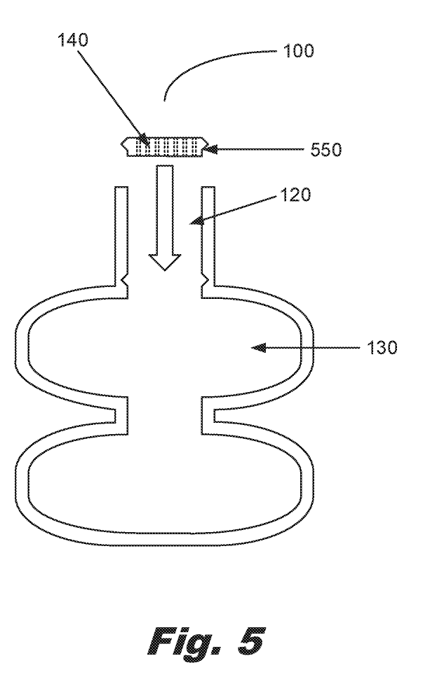

FIG. 5 shows an example of a device (100) for cleaning eyelashes according to one example consistent with the present disclosure. The device (100) includes a reservoir (130) to be filled with cleaning liquid. A plate (550) is inserted into the top of the device to form a basin (120) open on the top. The plate (550) includes multiple vents (140) which allow cleaning fluid to move between the basin (120) and the reservoir (130) and induce turbulence in the liquid as the liquid enters the basin (120).

The basin (120) is located above the reservoir (130). Compression of the reservoir (130) moves cleaning liquid from the reservoir (130) through the vents (140) in the plate (550) and into the basin (120). The liquid passing through the vents (140) produces agitation of the liquid in the basin (120). The agitation of the liquid speeds the cleaning of the eyelashes and/or eyelash extensions in the liquid.

In this example, reservoir (130) compresses vertically and has pleated sides to facilitate compression. Other variations are possible, including buttons, slides, triggers, etc. to reduce the volume inside the reservoir and display liquid from the reservoir (130) through the vents (140) and into the basin (120).

The plate (550) forms part of the basin (120). The plate (550), as shown in FIG. 5, may be a snap fit piece. The plate may be molded into the other parts of the device (100). The plate (550) may be screwed onto place. The basin (120) may attach to the reservoir (130) by snap fit, threads, adhesive, etc. The plate (550) includes multiple vents (140). The vents (140) may run orthogonal to the surface of the plate (550). The vents (140) may be angled relative to a surface of the plate (550).

The upper surface of the plate (550) may be substantially flat. The upper surface of the plate (550) may be concave. The upper surface of the plate (550) may be dimpled to direct liquid into the vents (140) when the liquid is flowing from the basin (120) into the reservoir (130).

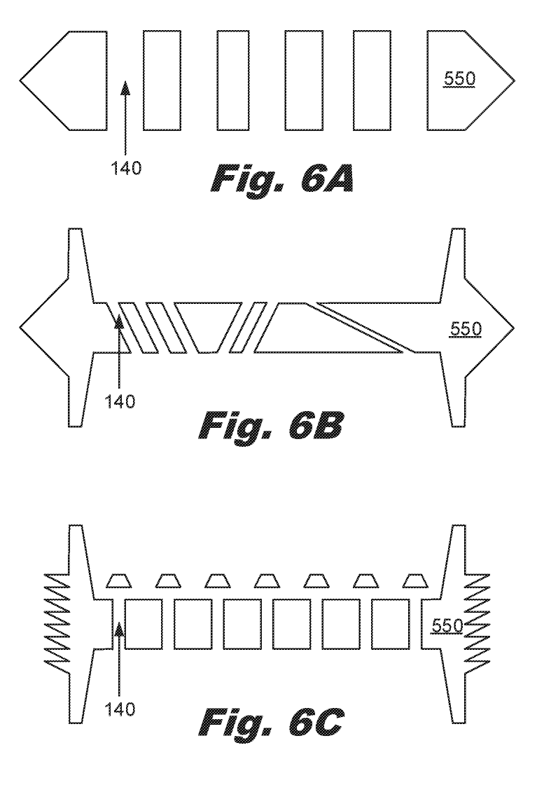

FIG. 6A-C show some examples of plates (550) with vents (140) consistent with the present specification. The plate (550) forms part of the basin (120) which contains agitated liquid to clean the eyelashes.

FIG. 6A shows a plate (550) with multiple vents (140). The vents (140) include tapered tops which serve to reduce the velocity of the liquid as the liquid comes into the basin (120) and aid in channeling the liquid back to the vents (140) and into the reservoir (130) when the reservoir is allowed to recover. This plate (550) includes features to allow the plate (550) to snap fit against the walls of the basin (120). Using separate pieces for the plate (550) and the reservoir (130) allows the economical use of different materials, for example, a more elastic material for the reservoir (130) and a more hydrophilic material for the plate (550).

FIG. 6B shows a plate (550) where the vents (140) are not orthogonal to the surfaces of the plate (550). The liquid may travel substantially vertically into the plate (550), this may cause the liquid to come out into the basin with to much vertical momentum, cause the liquid to spray. In contrast, by arranging the vents (140) to induce a lateral component sprays can be reduced. The exits of the vents (140) may be arranged to increase mixing in the basin (120).

FIG. 6C shows a plate (550) with a set of vents (140). Located above the output of the vents are deflectors to deflect the liquid laterally. In an example, the deflectors are an integrated part of the plate (550). The deflectors may be a diffusion plate, for example, a smaller version of diffusion plates used refining columns. FIG. 6C shows an example of threading to secure the plate (550) against the walls of the basin (120). In an example, a vent (140) may also serve as a socket to receive a screwdriver and/or wrench (e.g. a hex wrench) to facilitate rotation of the plate (550) to position and/or remove the plate. An additional plate(s) may be added above and/or below the plate (550). Such plates may modify the flow the liquid between the reservoir (130) and the basin (120). In an example, the plate (550) may be inverted to produce a different flow pattern. In another example, the plate (550) and sides of the basin (120) are poka-yoke, (can be assembled in a single orientation) to prevent incorrect assembly.

The plate 550 may be a mesh, for example, a metal and/or polymer mesh. In such an example, an upper piece forming the walls of the basin (120) may attach onto the reservoir (130) and hold the mesh in position.

It will be appreciated that, within the principles described by this specification, a vast number of variations exist. It should also be appreciated that the examples described are only examples, and are not intended to limit the scope, applicability, or construction of the claims in any way.

What is claimed is:

1. A device for washing eyelashes or eyelash extensions; comprising:
a basin comprising a vent; and
a compressible reservoir, the reservoir providing fluid to the basin through the vent and receiving fluid from the basin through the vent.

2. The device of claim 1, wherein the basin is sized to accommodate the eyelashes of a single eye.

3. The device of claim 1, wherein the basin rests on the compressible reservoir.

4. The device of claim 3, wherein the basin is removably attached to the reservoir.

5. The device of claim 1, further comprising an ultrasonic agitator to vibrate the fluid in the basin.

6. The device of claim 1, wherein the vent comprises a plurality of vents.

7. The device of claim 1, further comprising a shutter, wherein the shutter adjusts the size of the vent.

8. The device of claim 7, wherein the shutter slides along the vent.

9. The device of claim 7, wherein the shutter obstructs a portion of the vent.

10. The device of claim 1, wherein the compressible reservoir is manually compressed by the user during user of the device.

11. A device for washing eyelashes and eyelash extensions, comprising:
a basin, the basin comprising a vent;
a reservoir supporting the basin, wherein compressing the reservoir provides fluid to the basin and allowing the reservoir to relax allows the fluid to return to the reservoir.

12. The device of claim 11, wherein the reservoir comprises a fill line, indicating an amount of liquid to be used when using the device.

13. The device of claim 11, wherein the reservoir comprises a weep hole to reduce overfilling.

14. A method of cleaning eyelashes and eyelash extensions, comprising:
providing fluid through a vent into a basin, where passage through the vent agitates the fluid in the basin;
introducing eyelashes or eyelash extensions into the basin; and
retrieving the fluid through the vent from the basin.

15. The method of claim 14, further comprising: repeating providing and retrieving the fluid until the eyelashes or eyelash extensions are clean.
